(19) United States
(12) Patent Application Publication
(10) Pub. No.: US 2008/0159766 A1
(43) Pub. Date: Jul. 3, 2008

(54) IMAGE FORMING APPARATUS AND DENSITY ADJUSTING METHOD

(75) Inventor: Kunihiko Tanaka, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 11/960,047

(22) Filed: Dec. 19, 2007

(30) Foreign Application Priority Data
Dec. 28, 2006 (JP) 2006-354939

(51) Int. Cl. G03G 15/00

(52) U.S. Cl. 399/74

(57) ABSTRACT

An apparatus prohibits an unfair copying of a document by forming a latent image region and a background region on the document in a manner that prevents detection of their existence. The apparatus has a controller that detects background region densities and latent image region densities. The controller extracts only a background region density, which enables a special dot pattern to be detected when copying the image of the document. The controller also extracts only a latent image region density, at which a dot image corresponding to the dots constituting the latent image region is not formed on a copy when copying the image of the document. The controller then derives the background region densities and the latent image region density matching with the background region density.

### BACKGROUND OF THE INVENTION

1. Field of the Invention

The present invention relates to a technology for preventing leakage and counterfeit of confidential information due to an unfair copying of an important document such as a confidential document.

2. Description of the Related Art

Conventionally, a function of preventing unfair reading and outputting of an image has been requested with respect to an image forming apparatus and an image reading apparatus, such as a complex machine and a copying machine. Especially in business organizations, an outward leakage of confidential information due to an unfair reading of a confidential document causes a big problem. Accordingly, a technology of assuredly preventing and restricting the reading of a confidential document and the like has been strongly demanded.

As technologies for meeting such request and demand, Japanese Patent Unexamined Publication Nos. 2005-094327 and 2005-236954, for example, disclose a pattern processing technology which is widely known. This technology utilizes characteristics of scanners and printers to allow characters and the like to appear at a time of copying an image of a document. This pattern processing technology utilizes the characteristic that tiny dots existing on a document disappear (not formed on a copy) at a time of copying. Two areas including a latent image region having a group of small dots and a background region having a group of large dots are used so as to allow characters such as “COPY” and “COPY PROHIBITED” to appear as a background on a sheet onto which an image of a confidential document is to be outputted.

On the other hand, Japanese Patent Unexamined Publication No. 2004-274092 discloses a technology of determining the need for prohibiting an output of a document image. According to this technology, a special dot pattern is formed on a background of a sheet at a time of outputting an image of a confidential document, and the special dot pattern formed on the background image is detected at the time of copying. Then, the detected background dot pattern is compared with an output prohibiting dot pattern stored in a memory area to detect matching and non-matching of the patterns. Hereinafter, this technology is referred to as a copy guard technology.

Meanwhile, in recent years, the above-described pattern processing technology and copy guard technology are sometimes used in combination. For example, the background region used in the pattern processing technology is formed of the special dot pattern used in the copy guard technology. This allows an unfair output to be prohibited in a device which can detect the dot pattern. Further, even in a device which cannot detect the dot pattern, characters appear on a copy. Accordingly, an effect of preventing the unfair output can be expected.

Here, in the technology in combination as described above, it is preferable to make a difference between the density of the latent image region and the density of the background region be small so that existence of the latent image region and the background region cannot be found out. However, merely making the difference between the density of the latent image region and the density of the background region be small would not be enough. For example, in a case where both the densities of the background region and latent image region are too high, it causes a problem that the dots constituting the latent image region do not disappear at a time of copying so that characters do not appear. On the other hand, in a case where both the densities of the background region and latent image region are too low, it causes a likelihood that the special dot pattern included in the background region cannot be detected at the time of copying, so that an unfair copying cannot be prohibited.

### SUMMARY OF THE INVENTION

The present invention was made to solve the problems described above, and its object is to provide an image forming apparatus and a density adjusting method capable of prohibiting an unfair copying by forming a latent image region and a background region on a document in a manner such that existence of the latent image region and the background region cannot be found out at one view, assuredly making dots constituting the latent image region to disappear at a time of copying to allow characters for preventing the unfair output and the like to appear, and assuredly detecting the special dot pattern formed on the background region.

An image forming apparatus in accordance with one aspect of the present invention comprises: an image forming section for forming an image on a sheet; an image reading section for reading an image on a document by a photoelectric conversion; a pattern image forming instructing section operable to receive an instruction of forming a pattern image on a sheet, and adapted for instructing the image forming section to perform an image forming operation of forming a pattern image including a latent image region having a group of dots and a background region having dots whose diameters are larger than those of dots constituting the latent image region and forming a certain dot pattern; a density adjustment image forming instructing section operable to receive an instruction of forming a density adjustment image on the sheet, and adapted for instructing the image forming section to perform an image forming operation of forming a density adjustment image including a plurality of latent image region density areas having densities to be selectively adopted in the latent image region and a plurality of background region density areas having densities to be selectively adopted in the background region; an image reading instructing section for instructing the image reading section to perform an image reading operation of reading the sheet outputted in accordance with the instruction given by the density adjustment image forming instructing section; a density detecting section for detecting a plurality of latent image region densities of areas corresponding to the plurality of latent image region density areas and a plurality of background region densities of areas corresponding to the plurality of background region density areas of the image of the sheet read in accordance with the instruction given by the image reading instructing section; a background region density extracting section for extracting a background region density, which enables the dot pattern to be detected at a time of copying the image of the document having a background region on which the dot pattern is formed, from the plurality of background region densities detected by the density detecting section; a latent image region density extracting section for extracting a latent image region density, at which a dot image corresponding to the dots constituting the latent image region is not formed on a copy in a case of copying the image of the document having the latent image region, from the plurality of latent image region densities detected by the density detecting section; and a deriving section for deriving the background region density extracted by the background region density extracting section and the latent image region density being within a predetermined range from the background region density and extracted by the latent image region density extracting section.

A density adjusting method in accordance with another aspect of the present invention includes a density adjusting method for adjusting a density of an image including a latent image region having a group of dots and a background region having dots whose diameters are larger than those of dots constituting the latent image region and forming a certain dot pattern. The method comprises the steps of: (a) forming a density adjustment image including a plurality of latent image region density areas having densities for use in the latent image region and a plurality of background region density areas having densities for use in the background region on a sheet; (b) reading the density adjustment image formed on the sheet by a photoelectric conversion process; (c) detecting a plurality of latent image region densities of areas corresponding to the plurality of latent image region density areas and a plurality of background region densities of areas corresponding to the plurality of background region density areas of the image of the sheet read in step (b); (d) extracting a background region density, which enables the dot pattern to be detected at a time of copying the image of the document having a background region on which the dot pattern is formed, from the plurality of background region densities detected in step (c); (e) extracting a latent image region density, at which a dot image corresponding to the dots constituting the latent image region is not formed on a copy in a case of copying the image of the document having the latent image region, from the plurality of latent image region densities detected in step (c); and (f) deriving the background region density extracted in step (d) and the latent image region density being within a predetermined range from the background region density and extracted in step (e).

These and other objects, features and advantages of the present invention will become more apparent upon reading of the following detailed description along with the accompanied drawings.

### BRIEF DESCRIPTION OF THE DRAWINGS

FIG. 1 is a side view schematically showing an internal configuration of a complex machine which is an example of an image forming apparatus in accordance with a present embodiment.

FIG. 2 is a block diagram showing an electrical configuration of the complex machine.

FIG. 3 shows an example of sheets on which sample images used for an adjustment of densities of the background region and the latent image region.

FIG. 4 shows combinations of the latent image region densities and the background region densities which are detected from the sample images by a detecting portion.

FIG. 5 shows a state where only densities (combinations), which enable a copy prohibiting dot pattern to be normally detected in a case of copying an image of a document having the background region on which the copy prohibiting dot pattern is formed, are extracted from among the combinations shown in FIG. 4.

FIG. 6 shows a state where only densities (combinations), which are selectively set as the density of the latent image region and allows an image of dots constituting the latent image region not to be formed on a copy even in a case where a document having the latent image region of that density, are extracted from among the combinations shown in FIG. 4.

FIG. 7 shows combinations of the latent image region densities and the background region densities which are notified to a user.

FIG. 8 is a flowchart illustrating an operation of the complex machine shown in FIG. 2.

FIG. 9 shows a first modified example of sheets on which sample images are formed.

FIG. 10 shows a second modified example of a sheet on which a sample images is formed.

FIG. 11 is a block diagram showing an electrical configuration of a complex machine in accordance with a modified example of the present embodiment.

### DETAILED DESCRIPTION OF THE PREFERRED EMBODIMENTS

Hereinafter, an embodiment of the present invention will be described with reference to the attached drawings. It should be understood that the embodiment which will be described herebelow is an example which embodies the present invention, and does not have a characteristic of limiting a technical scope of the present invention.

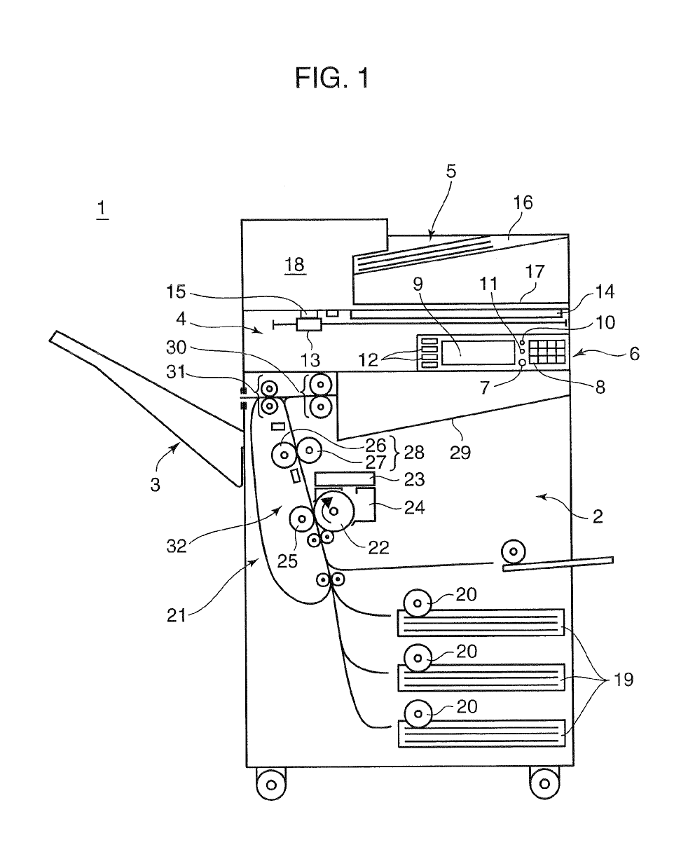

FIG. 1 is a side view schematically showing an internal configuration of a complex machine. A complex machine 1 has functions such as a copying function, a printer function, a scanner function, and a facsimile function, and is provided with a main body 2, a stack tray 3 arranged on the left side of the main body 2, a document reading section 4 arranged in an upper side of the main body 2, and a document feeding section 5 arranged on the document reading section 4.

Further, on a front portion of the complex machine 1, there is provided an operating section 6. The operating section 6 includes a start key 7 for allowing a user to input a print executing instruction, numerical keys 8 for inputting the number of prints and the like, a display portion 9 adapted to display operation guide information of various copying operations and composed of a liquid crystal display and the like having a touch panel function for inputting those various settings, a reset key 10 for resetting contents of settings set through the display portion 9, a stop key 11 for stopping a printing (image-forming) operation under execution, and a function switching key 12 for switching functions between the copying function, the printer function, the scanner function, and the facsimile function.

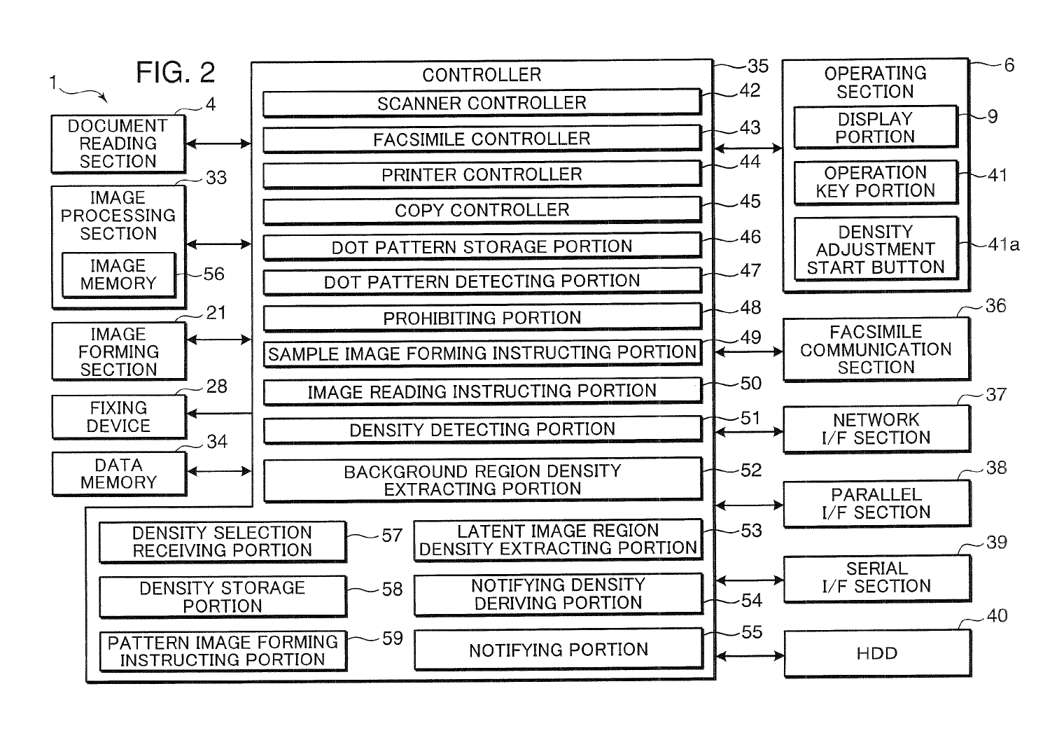

The document reading section 4 has a scanner portion 13 composed of a CCD (Charge Coupled Device) sensor and an exposure lamp, a document holder 14 composed of a transparent member such as glass, and a document reading slit 15. The scanner portion 13 is so configured as to be movable by an unillustrated driving portion. When the scanner portion 13 reads a document placed on the document holder 14, it is moved along a document surface at positions facing the document holder 14 and outputs image data obtained by scanning the document image to a controller 35 (refer to FIG. 2). Further, when the scanner portion 13 reads a document fed by the document feeding section 5, it is moved to a position facing a document reading slit 15 to obtain an image of a document through the document reading slit 15 in synchronization with a document conveying operation performed by the document feeding section 5, and then outputs the image data to the controller 35.

The document feeding section 5 has a document holding portion 16 for holding a document, a document discharging portion 17 for discharging a document whose image is read, and a document conveying mechanism 18. The document conveying mechanism 18 has sheet feeding rollers and conveying rollers (unillustrated) which are adapted to convey documents placed on the document holding portion 16 one after another to the position facing the document reading slit 15 and discharge the sheets to the document discharging portion 17. Further, the document conveying mechanism 18 has a sheet reversing mechanism (unillustrated) adapted to reverse front and back sides of the document and convey the document to the position facing the document reading slit 15 again so that images on both sides of the document can be read by the scanner portion 13 through the document reading slit 15.

Further, the document feeding section 5 is rotatably provided with respect to the main body 2 so that its front surface side can be moved upward. By moving the front surface side of the document feeding section 5 upward to open an upper surface of the document holder 14, an operator can place a document to be read, for example, an opened book and the like on the upper surface of the document holder 14.

The main body 2 includes a plurality of sheet-feeding cassettes 19, sheet feeding rollers 20 adapted to convey recording sheets one after another from the sheet-feeding cassettes 19 to the image forming section 21, and an image forming section 21 adapted to form an image onto the recording sheet conveyed from the sheet feeding cassette 19.

The image forming section 21 has an optical unit 23 adapted to output a laser light in accordance with image data obtained by the scanner portion 13 to allow a photoconductive drum 22 to be exposed to the laser light, a developing section 24 adapted to form a toner image on the photoconductive drum 22, a transferring section 25 adapted to transfer the toner image formed on the photoconductive drum 22 to the recording sheet, a fixing device 28 composed of a pair of rollers 26, 27 adapted to heat the recording sheet, onto which the toner image is transferred, to fix the toner image onto the recording sheet, and a pair of conveying rollers 30, 31 which are provided on a sheet conveying passage in the image forming section 21 and adapted to convey the recording sheet to the stack tray 3 or a sheet discharging tray 29.

Further, in a case of forming images on both sides of the recording sheet, the image forming section 21 forms an image on one side of the recording sheet, and thereafter the recording sheet is placed between a pair of conveying rollers 30 on the side of the sheet discharging tray 29. In this state, the pair of conveying rollers 30 are reversely rotated to switch back the recording sheet. Then, the recording sheet is conveyed to the sheet conveying passage 32 so that it is conveyed again to an upstream area of the image forming section 21. After the image forming section 21 forms an image on the other side, the recording sheet is discharged to the stack tray 3 or the sheet discharging tray 29.

FIG. 2 is a block diagram showing an electrical configuration of the complex machine 1. As shown in FIG. 2, the complex machine 1 includes the document reading section 4, an image processing section 33, the image forming section 21, the fixing device 28, a data memory 34, a controller 35, the operating section 6, a facsimile communication section 36, a network I/F section 37, a parallel I/F section 38, a serial I/F section 39, and an HDD (Hard Disk Drive) 40.

The document reading section 4, the image processing section 33, the data memory 34, the controller 35, the operating section 6, and the network I/F section 37 realizes a network scanner function of sending obtained image data to a designated IP address. Further, the document reading section 4, the image processing section 33, the image forming section 21, the data memory 34, the controller 35, the operating section 6, and the facsimile communication section 36 realize a facsimile function. Furthermore, the image processing section 33, the image forming section 21, the controller 35, the operating section 6, the network I/F section 37, and the parallel I/F section 38 realizes a printer function. Furthermore, the document reading section 4, the image processing section 33, the image forming section 21, the controller 35, and the operating section 6 realize a copying function.

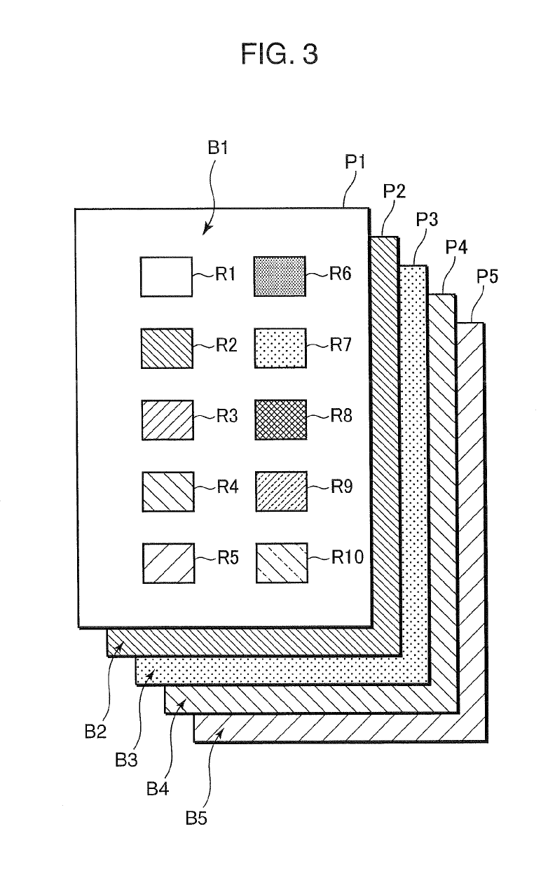

The operating section 6 corresponds to the operating section 6 shown in FIG. 1 and is used by a user to perform an operations related to the copying function, the printer function, the facsimile function, the scanner function, and the like, and it gives an operation instruction (command) and the like to the controller 35. The operating section 6 includes the display portion 9 having a touch panel and the like, and an operation key portion 41 having the above-described start key 7, the numerical keys 8, and the like. The operation key portion 41 is used by a user to perform input of various instructions such as a copy execution start instruction and a facsimile transmission start instruction. Further, as will be described hereinafter, the operation key portion 41 is also used for performing inputs of setting contents related to a resume operation (start-up operation) of the fixing device 28 from a sleep mode (print-waiting mode) or the like. Furthermore, for use in an adjustment of densities of a latent image region and a background region which will be described herebelow, the operation key portion 41 is provided with a density adjustment start button 41a for inputting an instruction to output a sheet on which a sample image shown in FIG. 3 is formed.

The document reading section 4 corresponds to the document reading section 4 shown in FIG. 1, and it optically obtains an image of a document to create image data.

The image processing section 33 executes various image processing with respect to image data. For example, the image processing section 33 executes various image processing (processing) including a predetermined correction processing such as a level correction and a γ correction, a compression or decompression processing, and an enlarging or reducing processing with respect to image data obtained by the document reading section 4 and the like. The image processing section 33 includes an image memory 56. The image processing section 33 stores the processed image data to the image memory 56 and outputs the image data to the image forming section 21, the facsimile communication section 36, the network I/F section 37, or the like.

The image forming section 21 corresponds to the above-described image forming section 21 and prints an image corresponding to image data of a document read out by the document reading section 4, image data received from an external computer or the like through the network I/F section 37, and image data including fax data received by the facsimile communication section 36 from an external facsimile device onto a predetermined recording sheet.

The data memory 34 includes a storage device which stores names of receivers and facsimile numbers of receivers of a short-cut button registration to be used at a time of performing a facsimile communication. Further, the data memory 34 stores IP address of receivers for use as a network scanner.

The controller 35 includes peripheral devices such as a RAM (Random Access Memory) and a ROM (Read Only Memory) for storing a program for defining operations of the CPU, and a RAM for temporarily storing data in its unillustrated CPU (Central Processing Unit). This allows the controller 35 to totally control over the complex machine 1 in accordance with instruction information received by the operating section 6 and the like, and detection signals outputted by sensors provided in the complex machine 1. More particularly, the controller 35 serves as a scanner controller 42, a facsimile controller 43, a printer controller 44, and a copy controller 45.

The program which is read by a computer as the controller 35 for realizing the above-described functions may be stored in a nonvolatile and large-capacity external storage device such as an HDD 40 and transferred in an appropriate manner to a main storage device such as a RAM, so that the program can be executed by the CPU. The program may be provided through a computer-readable recording medium such as a ROM and a CD-ROM, or may be provided through a transmission medium such as a network connected to the network I/F section 37. The transmission medium is not limited to a wired transmission medium but may be a wireless transmission medium. Further, the transmission medium may include not only a communication line but also a relay device for relaying the communication line, for example, a communication link such as a router.

In a case where the program is provided through a ROM, it may be executed by the CPU by mounting a ROM storing the program to the controller 35. In a case where the program is provided through a CD-ROM, it can be executed by the CPU by connecting a CD-ROM reading device to, for example, the parallel I/F section 38 and transferring the program to the RAM or the HDD 40. Further, when the program is provided through a transmission medium, it can be executed by the CPU by transferring the program received through the network I/F section 37 to the RAM or the HDD 40.

The scanner controller 42 controls operations of portions used for realizing the scanner function. The facsimile controller 43 controls operations of portions used for realizing the facsimile function. The printer controller 44 controls operations of portions used for realizing the printer function. The copy controller 45 controls operations of portions used for realizing the copying function.

The facsimile communication section 36 includes an encoding/decoding portion (not illustrated), a modem (not illustrated), and an NCU (Network Control Unit: not illustrated). The facsimile communication section 36 sends image data of a document read by the document reading section 4 to other facsimile machine through a phone line and an internet line, and receives image data sent from other facsimile machine. The encoding/decoding portion compresses and encodes image data which is to be transmitted, and expands and decodes image data which is received. The modem modulates the compressed and encoded image data to audio signals, and demodulates received signals (audio signal) to image data. Further, the NCU controls a connection to a recipient facsimile machine through a phone line.

The network I/F section 37 uses a network interface (for example, 10/100base-TX) and the like to control transmission of various data with respect to a user's server connected via a network. Further, when a plurality of terminal device such as personal computers and the like are connected to the network, the network I/F section 37 controls transmission of various data with respect to the terminal devices. For example, the network I/F section 37 sends document image data read by the document reading section 4 to a terminal device, and receives image data sent from the terminal device for printing in the image forming section 21.

The parallel I/F section 38 uses a high speed bidirectional parallel interface (for example, IEEE1284 compatible) or the like to receive print data from an external equipment or the like by means of a parallel transfer which transfers data of a plurality of bits through a plurality of signal lines. The serial I/F section 39 uses a serial interface (for example, RS-232C) or the like to receive various data from an external equipment by means of a serial transfer which sequentially sends data one bit after another with use of a single signal line.

The HDD 40 stores image data read by the document reading section 4 and image data sent through a network, or an output format set for the image data. The image data stored in the HDD 40 is used not only for the complex machine 1. The image data is confirmed by a terminal device and transferred to a predetermined folder of the terminal device through the network I/F section 37, so that it may be used also for the terminal device.

Further, in the complex machine 1, various functions can be realized by combining the above-described functions. For example, a PC transmission function, an Email transmission function, a FAX transmission function, and the like may be realized as a scanner function. Here, the PC transmission function is a function of directly sending image data read from a document to a desired terminal device through a network. The Email transmission function is a function of sending image data read from a document directly to, for example, an unillustrated SMTP server through a network as an attached file of an electronic mail and sending the electronic mail from the SMTP server to a desired external terminal device through a network. The FAX transmission function is a function of directly sending image data read from a document to a desired facsimile and the like through a phone line or the like.

Meanwhile, the complex machine 1 of the present embodiment has a function of prohibiting copying of a document to which a pattern processing is applied, in other words, a document on which a latent image region having a group of small-diameter dots and a background region having a group of dots whose diameters are larger than those of dots constituting the latent image region and forming a certain dot pattern. To realize this function, the controller 35 further includes a dot pattern storage section 46, a dot pattern detecting portion 47, and a prohibiting portion 48, functionally.

The dot pattern storage portion 46 is adapted to store a predetermined dot pattern for prohibiting copying. Hereinafter, the dot pattern is referred to as a copy prohibiting dot pattern.

The dot pattern detecting portion 47 detects a dot pattern formed on the background region from image data obtained by an image reading operation of the document reading section 4. It should be understood that the dot pattern detecting portion 47 detects the dot pattern formed on the background region by means of a known pattern matching.

The prohibiting portion 48 compares a dot pattern detected by the dot pattern detecting portion 47 with a copy prohibiting dot pattern stored in the dot pattern storage section 46. When the copy prohibiting dot pattern detected by the dot pattern detecting portion 47 is matching with the copy prohibiting dot pattern stored in the dot pattern storage section 46, the prohibiting portion 48 prohibits an image forming operation of the document.

When the complex machine 1 performs a reading operation with respect to a document to which a pattern processing is applied but a copy prohibiting dot pattern is not formed on the background region, characters such as “COPY” and “COPY PROHIBITED” are formed on the background of the image.

Further, the controller 35, in addition the portions 42 through 48, functionally includes a sample image forming instructing portion 49, an image reading instructing portion 50, a density detecting portion 51, a background region density extracting portion 52, a latent image region density extracting portion 53, a notifying density deriving portion 54, a notifying portion 55, a density selection receiving portion 57, a density storage portion 58, and a pattern image forming instructing portion 59 to adjust a density of a latent image region and a density of a background region.

The sample image forming instructing portion 49 instructs the image forming section 21 to perform an output operation of outputting sheets on which sample images, which will be described herebelow, are formed when a density adjustment start button 41a is operated. As shown in FIG. 3 for example, the sample images are formed on a plurality of number (here, it is five) sheets P1 through P5. On each sheet, a plurality of (ten in FIG. 3) latent image region patch areas R1 through R10 having different densities from one another are formed as alternatives to be set as a density of the latent image region. In the sheets P1 through P5, areas B1 though B5 other than the latent image region patch areas R1 through R10 (background region density area) are formed as alternatives to be set as a density of the background region. The background region density areas B1 through B5 of the sheets P1 through P5 have densities different from one another.

It should be understand that the difference in hatching between those of the latent image region patch areas R1 through R10 and the background region density areas B1 through B5 of the sheets P1 through P5 in FIG. 3 shows that they have different densities. Further, the sample images are stored in advance in the controller 35, and the sample image forming instructing portion 49 reads the sample images stored in advance and outputs the read sample images to the image forming section 21 for printing when the density adjustment start button 41a is operated.

As described above, a plurality of latent image region patch areas R1 through R10 having different densities from one another are formed on each of a plurality of sheets P1 through P5, and the background region density areas B1 through B5 which are areas other than the plurality of latent image region patch areas R1 through R10 and have different densities from one another are formed respectively on the plurality of sheets P1 through P5 respectively. The plurality of sheets P1 through P5 is outputted. Thus, a user can visually confirm densities of the latent image regions and the background regions formed on the plurality of outputted sheets P1 through P5.

The image reading instructing portion 50 instructs the document reading section 4 to perform a reading operation with respect to the sheets on which the sample images are formed when an instruction of performing an operation of copying the sheets on which the sample images are formed, is inputted through an operation of the start key 7.

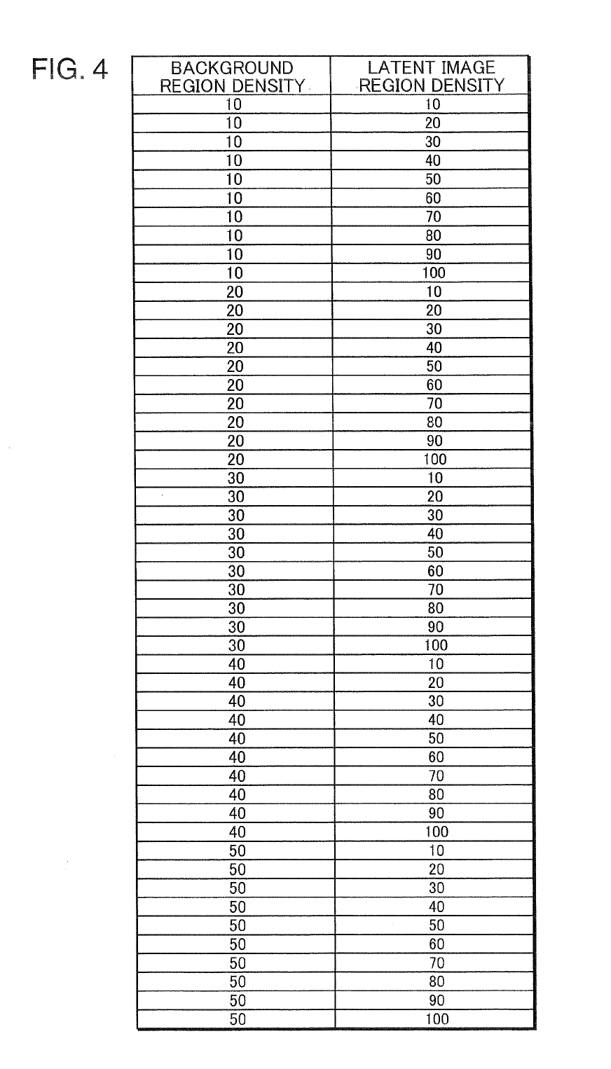

The density detecting portion 51 detects densities of the latent image region patch areas and densities of the background region density areas of the sample images obtained by the reading operation performed by the document reading section 4. FIG. 4 is a table showing combinations of densities of the latent image region patch areas (hereinafter, referred to as latent image region densities) and densities of the background region density areas (hereinafter, referred to as background region densities), which are detected by the density detecting portion 51 from the sample images.

The density detecting portion 51 creates a table showing combinations of the background region densities and the latent image region densities as shown in FIG. 4. For example, in FIG. 4, the background region densities “10” through “50” show detected densities of the background region density areas B1 through B5. Similarly, the latent image region densities “10” through “100” show detected densities of the latent image region patch areas R1 through R10.

In the present embodiment, the table showing combinations of the background region densities and the latent image region densities is created. However, the present invention is not especially limited to this. A table showing only the background region densities and a table showing only the latent image region densities may be created separately.

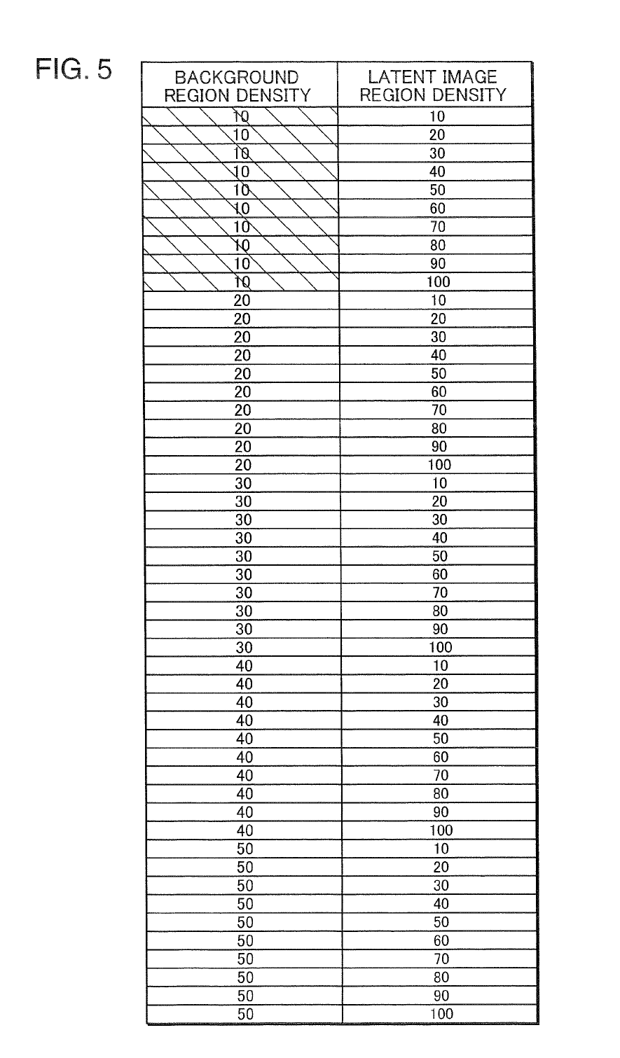

The background region density extracting portion 52 extracts densities, which enable the copy prohibiting dot pattern to be detected normally at a time of copying the image of the document having the background region on which the copy prohibiting dot pattern is formed, from the plurality of background region densities detected by the density detecting portion 51. For example, in FIG. 4, when it is provided that a copy prohibiting dot pattern formed on the background region cannot be read if a background region density of less than “20” is set as a background region density, the background region density extracting portion 52 extracts densities which are equal to or greater than “20” from the background region densities detected by the density detecting portion 51. The hatching of slanting lines in FIG. 5 indicates a background region density excluded from densities to be extracted by the background region density extracting portion 52.

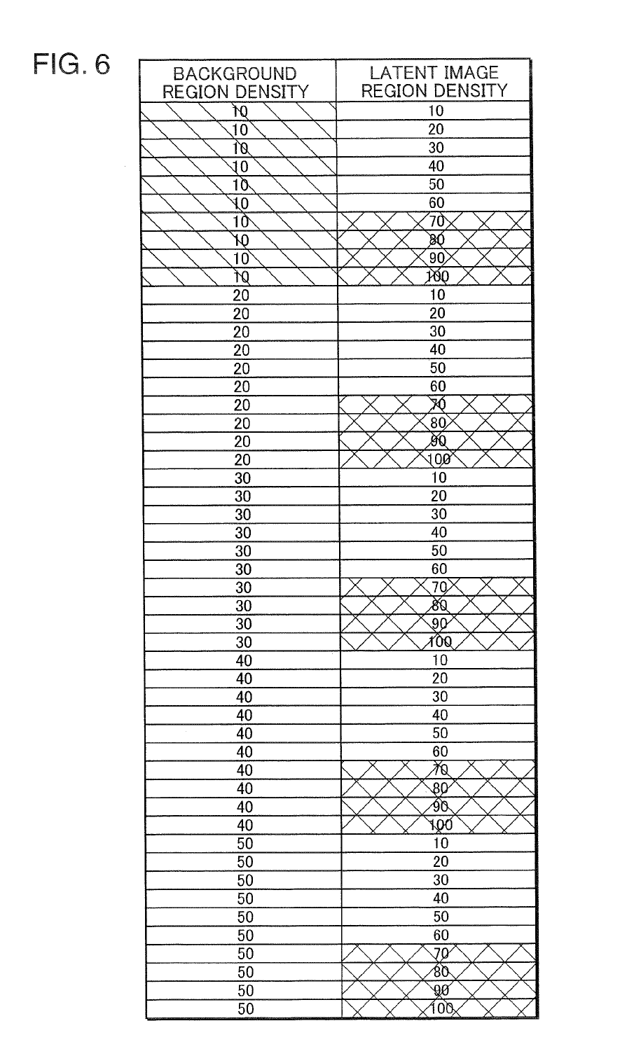

The latent image region density extracting portion 53 extracts densities, at which a dot image of dots constituting the latent image region is not formed on a copy in a case of copying the document having the latent image region, from a plurality of latent image portion densities detected by the density detecting portion 51. For example, in FIG. 4, when it is provided that a dot image constituting the latent image region appears on a copy if a document having a latent image region density of greater than “60” is set as a latent image region density, the latent image region density extracting portion 53 extracts densities which are equal to or less than “60” from the plurality of latent image region densities detected by the density detecting portion 51. The net-like hatching in FIG. 6 indicates latent image region densities excluded from densities to be extracted by the latent image region density extracting portion 53.

Thus, combinations of densities extracted by the background region density extracting portion 52 and the latent image region density extracting portion 53 are combinations of densities to which the hatching is not applied in FIG. 6.

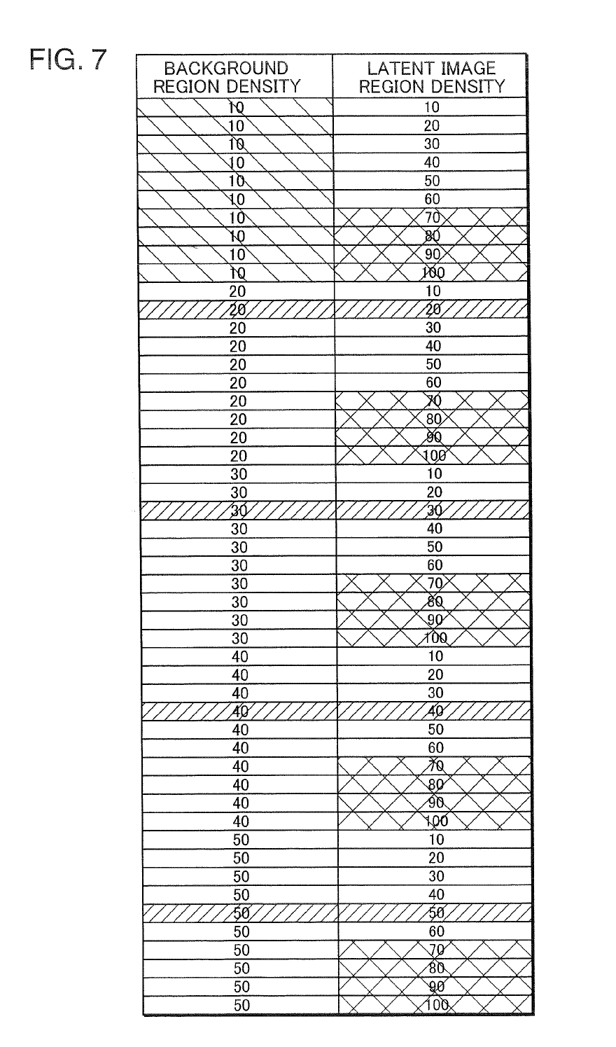

The notifying density deriving portion 54 derives combinations whose densities are matching from combinations of densities extracted by the background region density extracting portion 52 and densities extracted by the latent image region density extracting portion 53. When it is provided that combinations of densities extracted by the background region density extracting portion 52 and the latent image region density extracting portion 53 are indicated as (background region density, latent image region density), combinations of (20,20), (30,30), (40,40), and (50,50) are derived in the example shown in FIG. 7. In FIG. 7, combinations of the derived background region densities and the latent image region densities are hatched in a manner different from those shown in FIGS. 5 and 6.

The notifying portion 55 allows the display portion 9 to display densities derived by the notifying density deriving portion 54 to notify a user. For example, in the above-described example, the notifying portion 55 notifies combinations of (20,20), (30,30), (40,40), and (50,50) shown in FIG. 7 to a user. It should be understood that other form of notification may be adopted. Other than the form of allowing the display portion 9 to display only combinations in which the background region densities extracted by the background region density extracting portion 52 and the latent image region densities extracted by the latent image region density extracting portion 53 are matching, a form of allowing the display portion 9 to display all of combinations of the background region densities extracted by the background region density extracting portion 52 and the latent image region densities extracted by the latent image region density extracting portion 53 and making display forms of combinations in which both densities matching be different from other display forms of combinations (for example, reversing black and white, and coloring) may be adopted.

The density selection receiving portion 57 receives selection of a user's desired density from a plurality of densities displayed by the display portion 9 when the notifying density deriving portion 54 derives the plurality of densities. The density storage portion 58 stores density received by the density selection receiving portion 57.

The pattern image forming instructing portion 59 receives an image forming instruction of forming on a sheet a pattern image including a latent image region having a group of dots and a background region having dots whose diameters are larger than those of dots constituting the latent image region and forming a certain dot pattern, and then instructs the image forming section 21 to perform an image forming operation of forming the pattern image. Further, the pattern image forming instructing portion 59 instructs the image forming section 21 to perform an image forming operation of forming on a sheet the pattern image at densities derived by the notifying density deriving portion 54 when it receives the image forming instruction of forming on a sheet the pattern image including the latent image region and the background region.

In the present embodiment, the image forming section 21 corresponds to an example of an image forming section. The document reading section 4 corresponds to an example of an image reading section. The sample image forming instructing portion 49 corresponds to an example of a density adjustment image forming instructing section. The image reading instructing portion 50 corresponds to an example of an image reading instructing section. The density detecting portion 51 corresponds to an example of a density detecting section. The background region density extracting portion 52 corresponds to an example of a background region density extracting section. The latent image region density extracting portion 53 corresponds to an example of a latent image region density extracting section. The notifying density deriving portion 54 corresponds to an example of a deriving section. The notifying portion 55 corresponds to an example of a notifying section. The display portion 9 corresponds to an example of a display section. The density selection receiving portion 57 corresponds to an example of a density selection receiving section. The density storage portion 58 corresponds to an example of a density storage section.

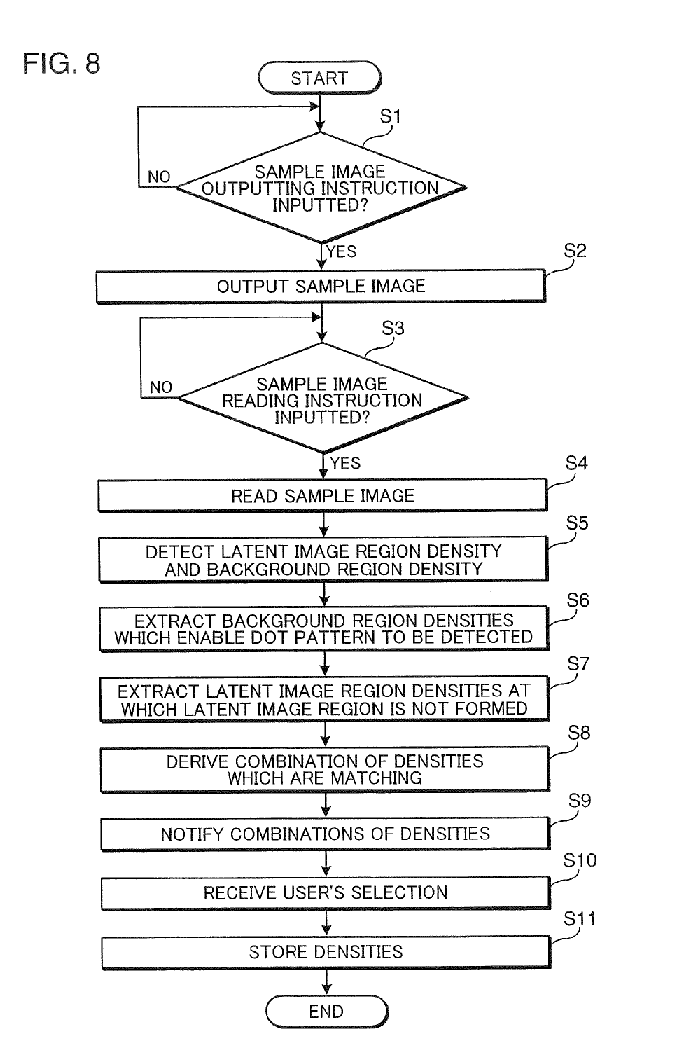

FIG. 8 is a flowchart illustrating an operation of the complex machine 1 shown in FIG. 2.

As shown in FIG. 8, the sample image forming instructing portion 49 determines whether or not a user operates the density adjustment start button 41a to input an instruction of performing an output operation of a sheet on which a sample image is formed (step S1). Here, when it is determined that the user does not operate the density adjustment start button 41a to input the instruction of performing the output operation of a sheet on which a sample image is formed (NO in step S1), the sample image forming instructing portion 49 waits until it receives the output instruction. On the other hand, when it is determined that the user operates the density adjustment start button 41a to input the instruction of performing the output operation of a sheet on which a sample image is formed (YES in step S1), the sample image forming instructing portion 49 allows the image forming section 21 to output, for example, the sheet on which the sample image is formed as shown in FIG. 3 (step S2).

Next, the image reading instructing portion 50 determines whether or not the user operates the start key 7 to input an instruction of performing an image reading operation with respect to the sheet on which the sample image is formed (step S3). Here, when it is determined that the user does not operate the start key 7 to input an instruction of performing an image reading operation with respect to the sheet on which the sample image is formed (NO in step S3), the image reading instructing portion 50 waits until it receives the image reading instruction. On the other hand, when it is determined that the user does not operate the start key 7 to input an instruction of performing an image reading operation with respect to the sheet on which the sample image is formed (YES in step S3), the image reading instructing portion 50 allows the document reading section 4 to read the sheet on which the sample image is formed (step S4).

Next, the density detecting portion 51 detects a plurality of background region densities of areas corresponding to a plurality of background region density areas and a plurality of latent image region densities of areas corresponding to a plurality of latent image region patch areas from the image obtained by the image reading operation performed by the document reading section 4 (step S5). Next, the background region density extracting portion 52 extracts background region densities, which enable the dot pattern to be detected at a time of setting the same as a density of the background region, from the plurality of background region densities detected (step S6). The controller 35 stores in advance a density range which does enable the dot pattern not to be normally detected, and the background region density extracting portion 52 extracts background region densities which do not fall within the density range from the plurality of background region densities which are detected.

Next, the latent image region density extracting portion 53 extracts only latent image region densities, at which a dot image constituting a latent image region is not formed on a copy at a time of setting the same as a density of the latent image region and copying a document having the latent image region, from the plurality of latent image region densities detected (step S7). The controller 35 stores in advance a density range at which the dot image constituting the latent image region is formed on a copy, and the latent image region density extracting portion 53 extracts latent image region densities which do not fall within the density range from the plurality of latent image region densities which are detected.

Next, the notifying density deriving portion 54 derives combinations in which the background region densities extracted by the background region density extracting portion 52 in step S6 and the latent image region densities extracted by the latent image region density extracting portion 53 in step S7 are matching (step S8).

As shown in FIG. 7, the notifying density deriving portion 54 of the present embodiment derives combinations in which the background region densities extracted by the background region density extracting portion 52 and the latent image region densities extracted by the latent image region density extracting portion 53 are completely matching. However, the present invention is not especially limited to this. The notifying density deriving portion 54 may derive combinations having the differences between the extracted background region densities and the extracted latent image region densities are within a predetermined range, for example, within ±5 percent. In other words, the notifying density deriving portion 54 derives the background region densities extracted by the background region density extracting portion 52 and the latent image region densities being within the predetermined range from the background region densities and extracted by the latent image region density extracting portion 53.

Next, the notifying portion 55 allows the display portion 9 to display combinations of the derived densities to notify a user (step S9). Here, in a case where a plurality of combinations of derived densities exist, a plurality of combinations of densities are displayed by the display portion 9. The density selection receiving portion 57 receives a selection of a combination of densities desired by a user from a plurality of combinations of densities (step S10). The user operates the operation key portion 41 of the operating section 6 to select a desired combination of densities from a plurality of combinations of densities displayed by the display portion 9.

Next, the density selection receiving portion 57 stores a density of a background region density area and a density of a latent image region patch area in the density storage portion 58 in accordance with a selected combinations of densities. In a case where the notifying density deriving portion 54 derives one combination of densities, it stores a derived density of the background region density area and a derived density of the latent image region patch area in the density storage portion 58. In a case of forming a pattern image including the latent image region and the background region on a document, the image forming section 21 reads densities stored in the density storage portion 58 and then forms a pattern image including the latent image region and the background region on a document at the read density.

As described above, sheets on which sample images having a plurality of densities to be selectively set as a density of a background region and a plurality of densities to be selectively set as a density of a latent image region are formed in a plurality of combinations are outputted, and then the sheets on which the sample images are formed are read. A plurality of background region densities of areas corresponding to a plurality of background region density area and a plurality of latent image region densities of areas corresponding to a plurality of latent image region patch area are detected from image data which is obtained in such a manner. The background region densities, which enable a dot pattern to be normally detected at a time of setting the same as a density of the background region, are extracted from the plurality of background region densities detected. Further, the latent image region densities, at which a dot image constituting a latent image region is not formed on a copy at a time of setting the same as a density of the latent image region and copying a document having the latent image region, are extracted from the plurality of latent image region densities detected. Then, combinations in which the background region densities extracted by the background region density extracting portion 52 and the latent image region densities extracted by the latent image region density extracting portion 53 are substantially matching are derived, and the derived combinations are notified to a user.

Thus, a latent image region and a background region can be formed on a document so that existence of the latent image region and the background region cannot be found out at one view. Further, when the document is copied, an image of dots constituting the latent image region is assuredly prevented from appearing on a copy, so that characters for preventing unfair output come up. Accordingly, a copy prohibiting dot pattern formed on the background region can be assuredly detected to assuredly prohibit an unfair copying.

In the present embodiment, combinations derived by the notifying density deriving portion 54 are notified to a user. However, the present invention is not limited to this configuration. The controller 35, for example, may select a combination from a plurality of combinations in accordance with a predetermined selection reference, for example, select a combination in accordance with a selection reference of selecting a combination having largest densities or smallest densities. Further, a user can determine which combination is to be adopted in accordance with outputted sheets on which sample images are formed in density combinations derived by the notifying density deriving portion 54.

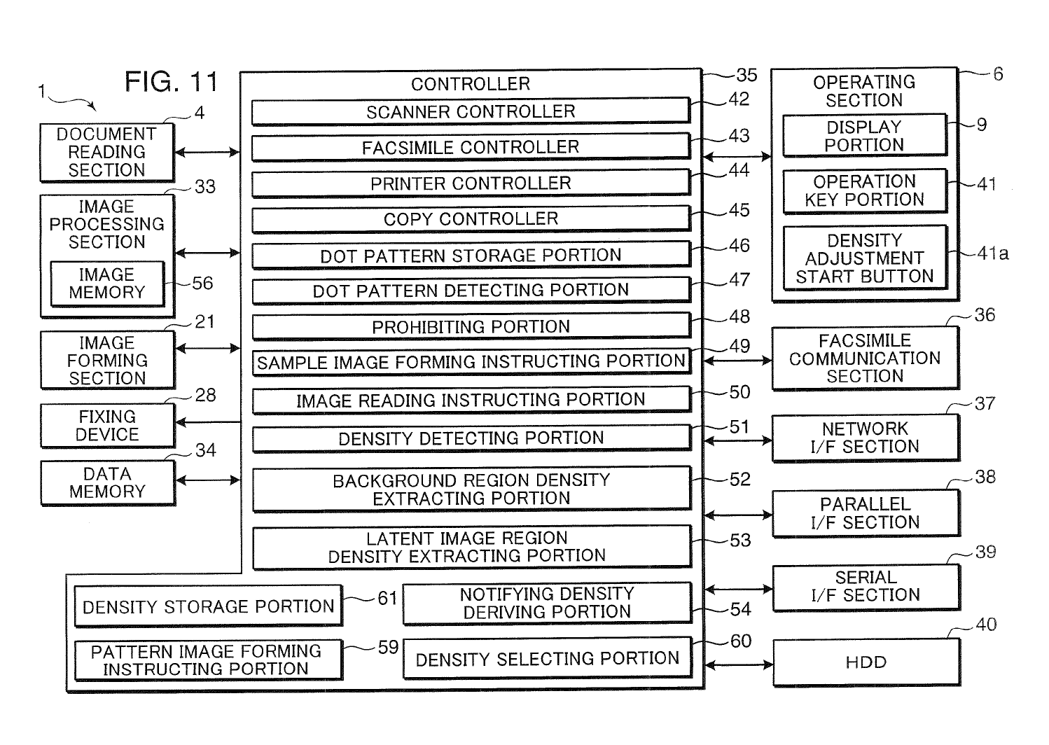

FIG. 11 is a diagram showing an electrical configuration of a complex machine in accordance with a modified example of the present embodiment. In FIG. 11, configurations which are the same as those of the complex machine 1 shown in FIG. 2 will be identified with the same reference numerals, and descriptions regarding those will be omitted. The controller 35 further includes, in addition to the sections 42 through 54, a density selecting portion 60 and a density storage portion 61, functionally. The density selecting portion 60 corresponds to an example of a selecting section, and the density storage portion 61 corresponds to an example of a density storage section.

The density selecting portion 60 selects a certain density in accordance with a predetermined selection reference from a plurality of densities derived when a plurality of densities are derived by the notifying density deriving portion 54. In particular, the density selecting portion 60 selects a combination having the greatest densities from the plurality of combinations of densities derived. For example, as shown in FIG. 7, when the notifying density deriving portion 54 derives combinations of densities of (background region density, latent image region density)=(20,20), (30,30), (40,40), (50,50), the density selecting portion 60 selects the combination (50,50) having the greatest densities.

The density storage portion 61 stores a combination of certain densities selected by the density selecting portion 60 i.e. a combination of the background region density and the latent image region density.

In the modified example of the present embodiment, the density selecting portion 60 selects the combination having the largest densities from a plurality of combinations of densities derived. However, as described above, a combination having the smallest density may be selected from a plurality of derived combinations densities. For example, as shown in FIG. 7, when the notifying density deriving portion 54 derives combinations of densities of (background region density, latent image region density)=(20,20), (30,30), (40,40), (50,50), the density selecting portion 60 selects the combination (20,20) having the smallest densities.

Further, the density selecting portion 60 may select intermediate values of the combination having the greatest densities and the combination having the smallest densities from a plurality of derived combinations of densities to set as densities of the background region and the latent image region.

As described above, a certain density is selected in accordance with a predetermined selection reference from densities derived by notifying density deriving portion 54. Accordingly, an optimal density can be automatically selected even if a plurality of densities are derived by the notifying density deriving portion 54.

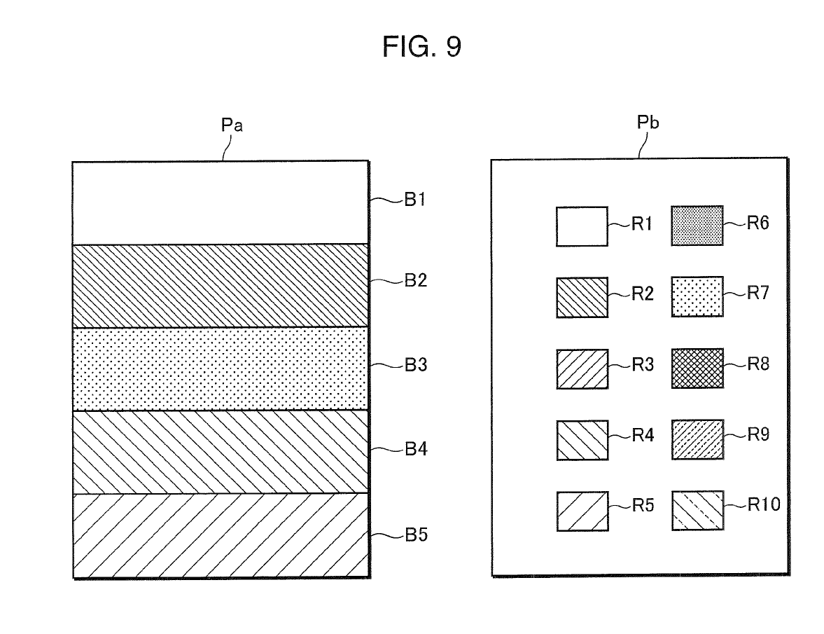

Further, in the present embodiment, a plurality of combinations of densities of the latent image region patch areas (latent image region densities) and densities of the background region density areas (background region density) are formed on a plurality of sheets. However, the present invention is not limited to this configuration. For example, as shown in FIG. 9, an image output area of one sheet Pa may be divided into a plurality of blocks having a number of selections of the background region densities (for example, five), and background region density areas B1 through B5 having different densities may be formed respectively on the blocks, and a plurality of latent image region patch areas R1 through R10 having different densities may be formed on another one sheet Pb.

As described above, a first sheet Pa including a plurality of background region density area B1 through B5 having different densities from one another, and a second sheet Pb including a plurality of latent image region patch areas R1 through R10 having different densities from one another are outputted. Thus, a user can visually confirm densities of the latent image regions formed on the outputted first sheet Pa and densities of the background regions formed on the outputted second sheet Pb.

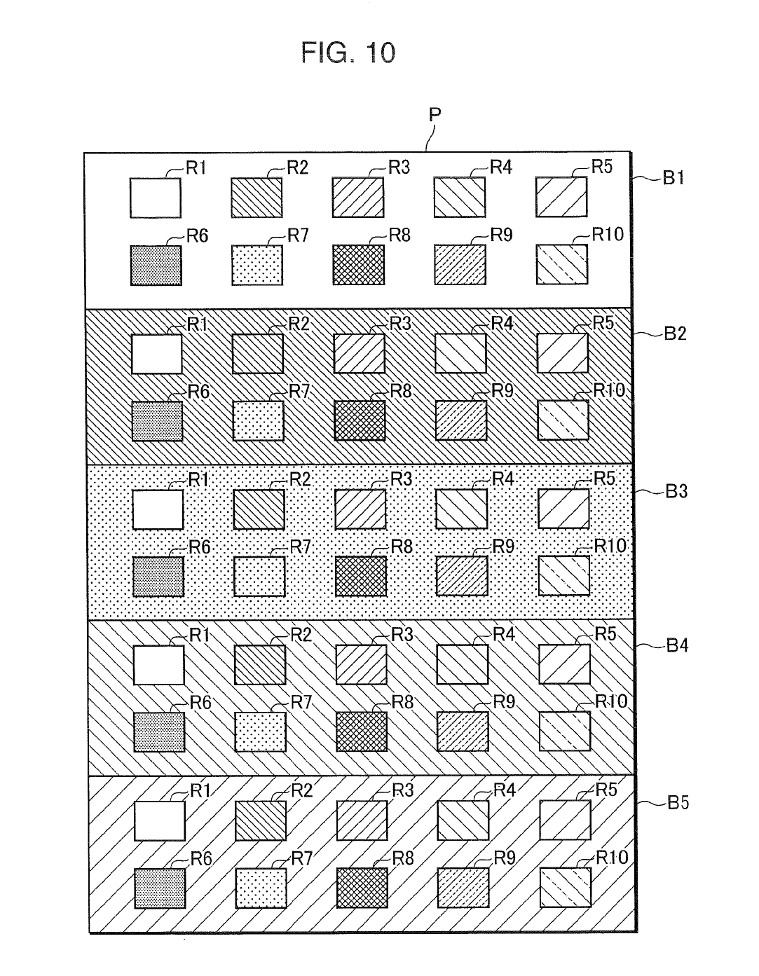

Alternatively, for example, as shown in FIG. 10, an image output area of one sheet P may be divided into a plurality of blocks having a number of selections of densities of the background region areas B1 through B5 (for example, five), and each block may have a plurality of latent image region patch areas R1 through R10 having different densities from one another.

As described above, a sheet P having a plurality of background region density areas B1 through B5 into which a whole sheet is divided, and having a plurality of latent image region patch areas R1 through R10 having different densities different from one another in each of the background region density areas B1 through B5 is outputted. Thus, a user can visually confirm densities of latent image regions and background regions formed on a sheet P to be outputted.

Further, in the present embodiment, a sheet on which sample images are formed is outputted by operation of the density adjustment start button 41a. However, the present invention is not limited to this. For example, in a case where the complex machine 1 is communicably connected to a personal computer, the complex machine 1 may output a sheet on which sample images are formed in accordance with an instruction inputted to the personal computer. In other words, the sheet on which the sample image is formed may be outputted in accordance with an instruction given by an external equipment which is communicably connected to the complex machine 1.

The above-described embodiment mainly includes the invention having the following configurations.

An image forming apparatus in accordance with one aspect of the present invention comprises: an image forming section for forming an image on a sheet; an image reading section for reading an image on a document by a photoelectric conversion; a pattern image forming instructing section operable to receive an instruction of forming a pattern image on a sheet, and adapted for instructing the image forming section to perform an image forming operation of forming a pattern image including a latent image region having a group of dots and a background region having dots whose diameters are larger than those of dots constituting the latent image region and forming a certain dot pattern; a density adjustment image forming instructing section operable to receive an instruction of forming a density adjustment image on the sheet, and adapted for instructing the image forming section to perform an image forming operation of forming a density adjustment image including a plurality of latent image region density areas having densities to be selectively adopted in the latent image region and a plurality of background region density areas having densities to be selectively adopted in the background region; an image reading instructing section for instructing the image reading section to perform an image reading operation of reading the sheet outputted in accordance with the instruction given by the density adjustment image forming instructing section; a density detecting section for detecting a plurality of latent image region densities of areas corresponding to the plurality of latent image region density areas and a plurality of background region densities of areas corresponding to the plurality of background region density areas of the image of the sheet read out in accordance with the instruction given by the image reading instructing section; a background region density extracting section for extracting a background region density, which enables the dot pattern to be detected at a time of copying the image of the document having a background region on which the dot pattern is formed, from the plurality of background region densities detected by the density detecting section; a latent image region density extracting section for extracting a latent image region density, at which a dot image corresponding to the dots constituting the latent image region is not formed on a copy in a case of copying the image of the document having the latent image region, from the plurality of latent image region densities detected by the density detecting section; and a deriving section for deriving the background region density extracted by the background region density extracting section and the latent image region density being within a predetermined range from the background region density and extracted by the latent image region density extracting section.

A density adjusting method in accordance with another aspect of the present invention includes a density adjusting method for adjusting a density of an image including a latent image region having a group of dots and a background region having dots whose respective diameters are larger than those of dots constituting the latent image region and forming a certain dot pattern. The method comprises the steps of: (a) forming a density adjustment image including a plurality of latent image region density areas having densities for use in the latent image region and a plurality of background region density areas having densities for use in the background region on a sheet; (b) reading the density adjustment image formed on the sheet by a photoelectric conversion process; (c) detecting a plurality of latent image region densities of areas corresponding to the plurality of latent image region density areas and a plurality of background region densities of areas corresponding to the plurality of background region density areas of the image of the sheet read in step (b); (d) extracting a background region density, which enables the dot pattern to be detected at a time of copying the image of the document having a background region on which the dot pattern is formed, from the plurality of background region densities detected in step (c); (e) extracting a latent image region density, at which a dot image corresponding to the dots constituting the latent image region is not formed on a copy in a case of copying the image of the document having the latent image region, from the plurality of latent image region densities detected in step (c); and (f) deriving the background region density extracted in step (d) and the latent image region density being within a predetermined range from the background region density and extracted in step (e).

According to these configurations, a background region density, which enables a dot pattern to be detected at a time of copying an image of a document having a background region on which the dot pattern is formed, is extracted from a plurality of background region densities detected by the density detecting section. Accordingly, the extracted background region density is used as a density of the background region, so that unfair copying of a document having a background region on which the dot pattern is formed can be prohibited.

Further a latent image region density, at which a dot image corresponding to dots constituting a latent image region is not formed on a copy at a time of copying the image of the document having the latent image region, is extracted from a plurality of latent image region densities detected by the density detecting section. Accordingly, in a case of copying a document having the latent image region, the dot image corresponding to dots constituting the latent image region is not formed on a copy assuredly, and an image for achieving an effect of preventing an unfair output can come up.

Then, the background region density extracted by the background region density extracting section, and the latent image region density being within a predetermined range from the background region density and extracted by the latent image region density extracting section are derived. Accordingly, a user can select optimal densities from the derived densities. Further, the apparatus can automatically select optimal densities from the derived densities.

In the above-described image forming apparatus, it is preferable that the pattern image forming instructing section instructs the image forming section to perform the image forming operation of forming the pattern image on the sheet at a background region density and a latent image region density derived by the deriving section when it receives an image forming instruction of forming the pattern image including the latent image region and the background region on the sheet. According to this configuration, the pattern image including the latent image region and the background region can be formed on a sheet at optimal densities.

In the above-described image forming apparatus, it is preferable that the deriving section derives a background region density extracted by the background region density extracting section, and a latent image region density matching with the background region density and extracted by the latent image region density extracting section.

According to this configuration, the background region density extracted by the background region density extracting section, and the latent image region density matching with the background region density and extracted by the latent image region density extracting section are derived, and the density of the background region and the density of the latent image region becomes equal. Accordingly, a density of a whole document having the background region and the latent image region is made uniform.

In the above-described image forming apparatus, it is preferable that the image forming apparatus further comprises a notifying section for notifying the background region density and the latent image region density derived by the deriving section. According to this configuration, the background region density and the latent image region density derived by the deriving section are notified. Accordingly, a user can select optimal densities from the plurality of background region densities and the plurality of latent image region densities.

In the above-described image forming apparatus, it is preferable that the notifying section includes a display section which displays a plurality of background region densities and a plurality of latent image region densities derived by the deriving section, and the image forming apparatus further comprises: a density selection receiving section for receiving a desirable background region density and a latent image region density selected by a user from the plurality of background region densities and the latent image region densities displayed by the display section.

According to this configuration, the plurality of background region densities and the plurality of latent image region densities derived by the deriving section is displayed by the display section, and a user's desirable selections of a background region density and a latent image region density from the plurality of background region densities and the plurality of latent image region densities which are displayed are received. Thus, even if the plurality of background region densities and the plurality of latent image region densities are derived, a user selects optimal background region density and latent image region density. Accordingly, at a time of copying, the dot pattern can be detected from the background region, so that the dot image of the latent image region is assuredly prevented from being formed on a copy, and an image for achieving an effect of prevent an unfair output comes up.

In the above-described image forming apparatus, it is preferable that the image forming apparatus further comprises: a density storage section for storing the background region density and the latent image region density received by the density selection receiving section, wherein, and that when the image forming instruction of forming a pattern image including a latent image region and a background region on a sheet is received, the pattern image forming instructing section reads a background region density and a latent image region density stored in the density storage section and instructs the image forming section to perform the image forming operation of forming a pattern image on the sheet at the background region density and the latent image region density which are read out.

According to this configuration, when the background region density and the latent image region density received by the density selection receiving section are stored in the density storage section, and the image forming instruction of forming the pattern image including the latent image region and the background region on a sheet is received, the background region density and the latent image region density stored in the density storage section are read. Then, the image forming section is instructed to perform the image forming operation of forming the pattern image on a sheet at the background region density and the latent image region density which are read. Thus, an image having the latent image region and the background region can be formed on a sheet in accordance with optimal background region density and optimal latent image region density selected by a user.

In the above-described image forming apparatus, it is preferable that the density adjustment image forming instructing section instructs the image forming section to perform an image forming operation of forming images onto a plurality of sheets, and each sheet includes a plurality of latent image region density areas having different densities from one another and a background region density area excluding the plurality of latent image region density areas and having a density different from that of background regions respectively formed on the other sheets.

According to this configuration, a plurality of sheets including a plurality of latent image region density areas having densities different from one another and a background region area excluding the plurality of latent image region density areas and having a density different from that of background regions respectively formed on the other sheets is outputted. Thus, a user can visually confirm densities of the latent image region and the background region formed on the plurality of sheets which are outputted.

In the above-described image forming apparatus, it is preferable that the density adjustment image forming instructing section instructs the image forming section to perform an image forming operation onto a first sheet including a plurality of background region density areas having densities different from one another and a second sheet including a plurality of latent image region density areas having densities different from one another.

According to this configuration, a first sheet including a plurality of background region density areas having densities different from one another and a second sheet including a plurality of latent image region density areas having densities different from one another are outputted. Thus, a user can confirm densities of background regions formed on the outputted first sheet and densities of latent image regions formed on the outputted second sheet.

In the above-described image forming apparatus, it is preferable that the density adjustment image forming instructing section instructs the image forming section to form an image in a plurality of background region density areas into which a whole sheet is divided and have densities different from one another, and includes a plurality of latent image region density areas having densities different from one another in each background region density area.

According to this configuration, an image in a plurality of background region density areas into which a whole sheet is divided and have densities different from one another, and includes a plurality of latent image region density areas having densities different from one another in each background region density area is outputted. Thus, a user can visually confirm densities of the latent image region and the background region formed on the outputted sheet.

In the above-described image forming apparatus, it is preferable that the image forming apparatus further comprises a selecting section for selecting a certain background region density and a latent image region density from the plurality of background region densities and the plurality of latent image region densities in accordance with a predetermined selection reference when the plurality of background region densities and the plurality of latent image region densities are derived by the deriving section.

According to this configuration, a certain background region density and a latent image region density are selected from the plurality of background region densities and the plurality of latent image region densities in accordance with a predetermined selection reference when the plurality of background region densities and the plurality of latent image region densities are derived by the deriving section. Accordingly, even when the deriving section derives a plurality of background region densities and a plurality of latent image region densities, an optimal background region density and a latent image region density can be automatically selected.

In the above-described image forming apparatus, it is preferable that the selecting section selects a background region density and a latent image region density respectively having a greatest density among the plurality of background region densities and the plurality of latent image region densities derived by the deriving section. According to this configuration, a background region density and a latent image region density respectively having a greatest density can be automatically selected from a plurality of background region densities and a plurality of latent image region densities derived by the deriving section.

In the above-described image forming apparatus, it is preferable that the selecting section selects a background region density and a latent image region density respectively having a smallest density among the plurality of background region densities and the plurality of latent image region densities derived by the deriving section. According to this configuration, a background region density and a latent image region density respectively having a smallest density can be automatically selected from a plurality of background region densities and a plurality of latent image region densities derived by the deriving section.

In the above-described image forming apparatus, it is preferable that the image forming apparatus further comprises a density storage section for storing a background region density and a latent image region density selected by the selecting section, and the pattern image forming instructing section reads a background region density and a latent image region density stored in the density storage section, and instructs the image forming section to perform an image forming operation of forming the pattern image onto the sheet at the background region density and the latent image region density which are read when it receives the instruction of forming the pattern image including the latent image region and the background region onto the sheet.

According to this configuration, when the background region density and the latent image region density selected by selecting section are stored in the density storage section, and an image forming instruction of forming a pattern image including the latent image region and the background region is received, the background region density and the latent image region density stored in the density storage section are read, and an instruction of performing an image forming operation of forming a pattern image on a sheet at the background region density and the latent image region density which are read is inputted to the image forming section. Thus, the pattern image including the latent image region and the background region can be formed on the sheet in accordance with the optimal background region density and latent image region density automatically selected by the apparatus.

According to the present invention, a latent image region and a background region can be formed on a document in a manner such that existence of the latent image region and background region cannot be found out at one view. Further, it solves a defect that dots constituting a latent image region do not disappear so that characters do not come up at a time of copying since densities of the background region and the latent image region are too high. Furthermore, it solves a defect that a special dot pattern which belongs to a background region cannot be detected so that unfair copying cannot be prohibited at a time of copying since densities of the background region and the latent image region are too low.

This application is based on Japanese Patent application serial No. 2006-354939 filed in Japan Patent Office on Dec. 28, 2006, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus comprising:
an image forming section for forming an image on a sheet;
an image reading section for reading an image on a document by a photoelectric conversion;
a pattern image forming instructing section operable to receive an instruction of forming a pattern image on a sheet, and adapted for instructing the image forming section to perform an image forming operation of forming a pattern image including a latent image region having a group of dots and a background region having dots whose diameters are larger than those of dots constituting the latent image region and forming a certain dot pattern;
a density adjustment image forming instructing section operable to receive an instruction of forming a density adjustment image on the sheet, and adapted for instructing the image forming section to perform an image forming operation of forming a density adjustment image including a plurality of latent image region density areas having densities to be selectively adopted in the latent image region and a plurality of background region density areas having densities to be selectively adopted in the background region;
an image reading instructing section for instructing the image reading section to perform an image reading operation of reading the sheet outputted in accordance with the instruction given by the density adjustment image forming instructing section;
a density detecting section for detecting a plurality of latent image region densities of areas corresponding to the plurality of latent image region density areas and a plurality of background region densities of areas corresponding to the plurality of background region density areas of the image of the sheet read in accordance with the instruction given by the image reading instructing section;
a background region density extracting section for extracting a background region density, which enables the dot pattern to be detected at a time of copying the image of the document having a background region on which the dot pattern is formed, from the plurality of background region densities detected by the density detecting section;
a latent image region density extracting section for extracting a latent image region density, at which a dot image corresponding to the dots constituting the latent image region is not formed on a copy in a case of copying the image of the document having the latent image region, from the plurality of latent image region densities detected by the density detecting section; and
a deriving section for deriving the background region density extracted by the background region density extracting section and the latent image region density being within a predetermined range from the background region density and extracted by the latent image region density extracting section.

2. The image forming apparatus according to claim 1, wherein the pattern image forming instructing section instructs the image forming section to perform the image forming operation of forming the pattern image on the sheet at a background region density and a latent image region density derived by the deriving section when it receives an image forming instruction of forming the pattern image including the latent image region and the background region on the sheet.

3. The image forming apparatus according to claim 1, wherein the deriving section derives a background region density extracted by the background region density extracting section, and a latent image region density matching with the background region density and extracted by the latent image region density extracting section.

4. The image forming apparatus according to claim 1, further comprising a notifying section for notifying the background region density and the latent image region density derived by the deriving section.

5. The image forming apparatus according to claim 4, wherein the notifying section includes a display section which displays a plurality of background region densities and a plurality of latent image region densities derived by the deriving section, and
the image forming apparatus further comprising: a density selection receiving section for receiving a desirable background region density and a latent image region density selected by a user from the plurality of background region densities and the latent image region densities displayed by the display section.

6. The image forming apparatus according to claim 5, further comprising a density storage section for storing the background region density and the latent image region density received by the density selection receiving section, wherein
when the image forming instruction of forming a pattern image including a latent image region and a background region on a sheet is received, the pattern image forming instructing section reads a background region density and a latent image region density stored in the density storage section and instructs the image forming section to perform the image forming operation of forming a pattern image on the sheet at the background region density and the latent image region density which are read out.

7. The image forming apparatus according to claim 1, wherein the density adjustment image forming instructing section instructs the image forming section to perform an image forming operation of forming images onto a plurality of sheets, and each sheet includes a plurality of latent image region density areas having different densities from one another and a background region density area excluding the plurality of latent image region density areas and having a density different from that of background regions respectively formed on the other sheets.

8. The image forming apparatus according to claim 1, wherein the density adjustment image forming instructing section instructs the image forming section to perform an image forming operation onto a first sheet including a plurality of background region density areas having densities different from one another and a second sheet including a plurality of latent image region density areas having densities different from one another.

9. The image forming apparatus according to claim 1, wherein the density adjustment image forming instructing section instructs the image forming section to form an image in a plurality of background region density areas into which a whole sheet is divided and have densities different from one another, and includes a plurality of latent image region density areas having densities different from one another in each background region density area.

10. The image forming apparatus according to claim 1, further comprising a selecting section for selecting a certain background region density and a latent image region density from the plurality of background region densities and the plurality of latent image region densities in accordance with a predetermined selection reference when the plurality of background region densities and the plurality of latent image region densities are derived by the deriving section.

11. The image forming apparatus according to claim 10, wherein the selecting section selects a background region density and a latent image region density respectively having a greatest density among the plurality of background region densities and the plurality of latent image region densities derived by the deriving section.

12. The image forming apparatus according to claim 10, wherein the selecting section selects a background region density and a latent image region density respectively having a smallest density among the plurality of background region densities and the plurality of latent image region densities derived by the deriving section.

13. The image forming apparatus according to claim 10, further comprising a density storage section for storing a background region density and a latent image region density selected by the selecting section, wherein
the pattern image forming instructing section reads a background region density and a latent image region density stored in the density storage section, and instructs the image forming section to perform an image forming operation of forming the pattern image onto the sheet at the background region density and the latent image region density which are read when it receives the instruction of forming the pattern image including the latent image region and the background region onto the sheet.

14. A density adjusting method for adjusting a density of an image including a latent image region having a group of dots and a background region having dots whose diameters are larger than those of dots constituting the latent image region and forming a certain dot pattern, the method comprising the steps of:
(a) forming a density adjustment image including a plurality of latent image region density areas having densities for use in the latent image region and a plurality of background region density areas having densities for use in the background region on a sheet;
(b) reading the density adjustment image formed on the sheet by a photoelectric conversion process;
(c) detecting a plurality of latent image region densities of areas corresponding to the plurality of latent image region density areas and a plurality of background region densities of areas corresponding to the plurality of background region density areas of the image of the sheet read in step (b);
(d) extracting a background region density, which enables the dot pattern to be detected at a time of copying the image of the document having a background region on which the dot pattern is formed, from the plurality of background region densities detected in step (c);
(e) extracting a latent image region density, at which a dot image corresponding to the dots constituting the latent image region is not formed on a copy in a case of copying the image of the document having the latent image region, from the plurality of latent image region densities detected in step (c); and
(f) deriving the background region density extracted in step (d) and the latent image region density being within a predetermined range from the background region density and extracted in step (e).
